(19) United States
(12) Patent Application Publication
(10) Pub. No.: US 2026/0155280 A1
(43) Pub. Date: Jun. 4, 2026

(54) Cold-Resistant Medium-Voltage Power Cable

(71) Applicant: Jiangsu Hengfeng Cable Co., Ltd., Yixing, Jiangsu (CN)

(72) Inventors: Hao SUN, Yixing, Jiangsu (CN); Junqiang LV, Yixing, Jiangsu (CN); Qun WANG, Yixing, Jiangsu (CN); Wanyun FU, Yixing, Jiangsu (CN)

(21) Appl. No.: 19/353,528

(22) Filed: Oct. 8, 2025

(30) Foreign Application Priority Data
Oct. 9, 2024 (CN) 2024113970635

(51) Int. Cl. H01B 7/28; H01B 7/18; H01B 7/24; H01B 7/32; H05B 1/02

(52) U.S. Cl. CPC H01B 7/28; H01B 7/185; H01B 7/24; H01B 7/324; H05B 1/0291

(57) ABSTRACT

The present disclosure relates to a cold-resistant medium-voltage power cable, includes a cable body, wherein a bending protection sleeve is slidably sleeved over an outer end of the cable body. Through the cooperative use of the bending protection sleeve, the clamping disc, the flexible electric heating patch, and the bending sensing assembly, on one hand, the arrangement reduces the difficulty in bending the cable body during installation, prevents damage to the cable body caused by excessive bending, and improves the efficiency and safety of installing the cable body in cold regions; on the other hand, the arrangement enables heating treatment at a bent installation section of the cable body. This configuration not only enhances flexibility of the cable body during installation, reducing damage to internal conductive cores of the cable body, but also provides continuous thermal protection to the bent installation section during subsequent operation of the cable body.

### CROSS-REFERENCE TO RELATED APPLICATIONS

This application claims priority to Chinese Patent Application No. 202411397063.5, filed on Oct. 9, 2024, which is incorporated herein by reference in its entirety.

### TECHNICAL FIELD

The present disclosure relates to a cold-resistant medium-voltage power cable, and more particularly, to a cold-resistant medium-voltage power cable applicable to the field of cables.

### BACKGROUND

Medium-voltage power cables generally refer to cables with a rated voltage in the range of 6 kV to 35 kV. These cables are widely used in distribution networks, industrial installations, and other fields requiring high-capacity power supply. The basic structure of a medium-voltage power cable includes a conductor core, an insulation layer, a shielding layer, and a protective layer. Among these, the conductor core is the central part of the cable, responsible for transmitting electrical energy; the insulation layer serves to isolate live parts from external electrical contact, ensuring the safe operation of the cable; and the shielding layer and the protective layer provide protection, preventing damage to the cable from external factors.

Due to the material properties of medium-voltage power cables, when these cables are installed and used in cold regions, the flexibility and electrical characteristics of the insulation layer, the shielding layer, and the protective layer can degrade. This degradation can cause the medium-voltage power cable to become hardened or cracked, which is detrimental to the application of medium-voltage power cables in cold regions.

Although some low-temperature resistant materials are already employed in medium-voltage power cables in the prior art, low temperatures can still adversely affect the flexibility of these cables. This is particularly true at bent sections of the medium-voltage cable during installation, where the combined effects of low temperature and bending stress make these sections highly susceptible to damage. This susceptibility reduces the durability of the medium-voltage power cable and compromises its safety during power transmission.

### SUMMARY

In view of the aforementioned prior art, the technical problem to be solved by the present disclosure is how to increase the durability of bent sections of a medium-voltage power cable when the cable is applied in cold regions.

To solve the above problem, the present disclosure provides a cold-resistant medium-voltage power cable, including: a cable body; wherein a bending protection sleeve is slidably sleeved over an outer end of the cable body; a clamping disc is bolted to each of a left end and a right end of the bending protection sleeve, and the clamping disc is slidably engaged with the cable body; a regulation protection cavity is provided inside the bending protection sleeve; a flexible electric heating patch is fixedly connected to an inner wall of the regulation protection cavity on a side thereof that is far from the cable body; and a bending sensing assembly configured to cooperate with the flexible electric heating patch is arranged between a left inner wall and a right inner wall of the regulation protection cavity.

The bending sensing assembly includes a trigger pad fixedly connected to each of the left inner wall and the right inner wall of the regulation protection cavity; an inner telescopic sensing coil is fixedly connected to a right end of the trigger pad that is fixed to the left inner wall of the regulation protection cavity; an outer telescopic sensing coil is fixedly connected to a left end of the trigger pad that is fixed to the right inner wall of the regulation protection cavity, and the outer telescopic sensing coil is located on an outer side of the inner telescopic sensing coil; an inner sensing contact block is fixedly connected to a right end of the inner telescopic sensing coil; an outer sensing contact block configured to cooperate with the inner sensing contact block is fixedly connected to a left end of the outer telescopic sensing coil; and the flexible electric heating patch is connected to the inner sensing contact block and the outer sensing contact block via wires.

In the aforementioned cold-resistant medium-voltage power cable, the arrangement not only reduces the difficulty in bending the cable body during installation, prevents damage to the cable body caused by excessive bending, but also provides continuous thermal protection to the bent installation section during subsequent operation of the cable body. This configuration reduces the degree to which the bent portion is affected by low temperatures, lowers the risk of the bent portion becoming hardened or even cracked, and ensures the safety and stability of the cable body during power transmission.

As a further improvement of the present disclosure, a microcontroller is further fixedly connected to a left side of a rear end of the bending protection sleeve; the microcontroller is loaded with a bending protection subsystem cooperating with a cable maintenance platform; the bending protection subsystem includes a bending protection processing unit; an input end of the bending protection processing unit is connected to a cable parameter acquisition unit and a bending sensing acquisition unit; and an output end of the bending protection processing unit is connected to a heat preservation protection unit and an abnormality alarm unit.

An input end of the cable parameter acquisition unit is in signal communication with the cable maintenance platform via a wireless signal transmitter; an input end of the bending sensing acquisition unit is in signal communication with the inner sensing contact block and the outer sensing contact block; an output end of the heat preservation protection unit is in signal communication with the flexible electric heating patch; and an output end of the abnormality alarm unit is in signal communication with the cable maintenance platform via a wireless signal transmitter.

As a supplement to the further improvement of the present disclosure, a power supply interface and a solar charging structure are respectively provided at a rear end of the microcontroller; and the power supply interface and the solar charging structure are connected to the microcontroller via independent lines.

As yet a further improvement of the present disclosure, a support lug is fixedly connected to each of a front end and a rear end of the clamping disc; a mounting hole is formed in the support lug; and the output end of the abnormality alarm unit is further in signal communication with an alarm light mounted on the support lug.

As still a further improvement of the present disclosure, the regulation protection cavity is filled with inert protective gas; a pressure regulating interface configured to communicate with the regulation protection cavity is fixedly connected to a right side of the rear end of the bending protection sleeve; the output end of the bending protection processing unit is further connected to an internal stress release unit; and an output end of the internal stress release unit is in signal communication with an electrically controlled valve provided on the pressure regulating interface.

As a supplement to the still further improvement of the present disclosure, the input end of the bending protection processing unit is further connected to a pressure acquisition unit; and an input end of the pressure acquisition unit is in signal communication with a pressure probe provided in the regulation protection cavity.

As another improvement of the present disclosure, the input end of the bending protection processing unit is further connected to a temperature difference data acquisition unit; and an input end of the temperature difference data acquisition unit is in signal communication with a first temperature probe provided on an inner wall of the regulation protection cavity and a second temperature probe provided on an outer end of the bending protection sleeve, respectively.

As still another improvement of the present disclosure, the output end of the bending protection processing unit is further connected to a constant force maintaining unit; electromagnetic repulsion plates are fixedly connected to an end of the flexible electric heating patch close to the cable body and to an end of the outer telescopic sensing coil far from the cable body, respectively; and an output end of the constant force maintaining unit is in signal communication with the electromagnetic repulsion plates.

In summary, through the cooperative use of the bending protection sleeve, the clamping disc, the flexible electric heating patch, and the bending sensing assembly, this arrangement provides enhanced protection for the bent installation section of the cable body when the cable body is installed in cold regions. On one hand, the arrangement reduces the difficulty in bending the cable body during installation, prevents damage to the cable body caused by excessive bending, and improves the efficiency and safety of installing the cable body in cold regions, while also utilizing an elastic protection mechanism to support the bent portion of the cable body, thereby reducing continuous damage to the cable body caused by the bending moment and prolonging the service life of the bent portion of the cable body in cold regions; on the other hand, the arrangement enables heating treatment at a bent installation section of the cable body. This configuration not only enhances flexibility of the cable body during installation, reducing damage to internal conductive cores of the cable body, but also provides continuous thermal protection to the bent installation section during subsequent operation of the cable body. As a result, the disclosed cable reduces the degree to which the bent portion is affected by low temperatures, lowers the risk of the bent portion becoming hardened or even cracked, improves the durability of the cable body after installation, and effectively ensures the safety and stability of the cable body during power transmission.

### BRIEF DESCRIPTION OF THE DRAWINGS

FIG. 1 is an axonometric view showing the cable body in a non-installed state cooperating with the bending protection sleeve according to Embodiments 1-3 of the present disclosure.

FIG. 2 is a control logic diagram of the bending protection subsystem according to Embodiments 2 and 3 of the present disclosure.

FIG. 3 is a front cross-sectional view of the bending protection sleeve with the cable body in a non-installed state according to Embodiments 1-3 of the present disclosure.

FIG. 4 is an exploded view of the bending protection sleeve according to Embodiments 1-3 of the present disclosure.

FIG. 5 is a diagram showing deformation of the bending protection sleeve as the cable body is adjusted according to an installation bending angle according to Embodiments 1-3 of the present disclosure.

FIG. 6 is an axonometric view of the bending protection sleeve after being stretched to trigger the bending sensing assembly according to Embodiments 1-3 of the present disclosure.

FIG. 7 is a top cross-sectional view of the bending protection sleeve with the cable body in a 90-degree bent state according to Embodiments 1 and 2 of the present disclosure.

FIG. 8 is a top cross-sectional view of the bending protection sleeve with the cable body in a bent state exceeding 90 degrees according to Embodiments 1 and 2 of the present disclosure.

FIG. 9 is a top cross-sectional view of the bending protection sleeve with the cable body in a 90-degree bent state according to Embodiment 3 of the present disclosure.

FIG. 10 is a top cross-sectional view of the bending protection sleeve with the cable body in a bent state exceeding 90 degrees according to Embodiment 3 of the present disclosure.

### DETAILED DESCRIPTION OF THE EMBODIMENTS

The following describes in detail three embodiments of the present disclosure with reference to the accompanying drawings.

### Embodiment 1

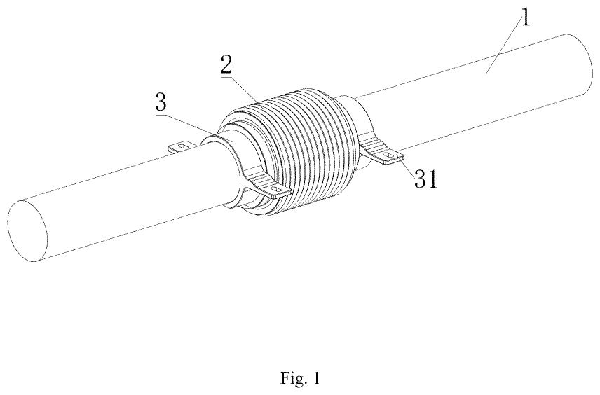

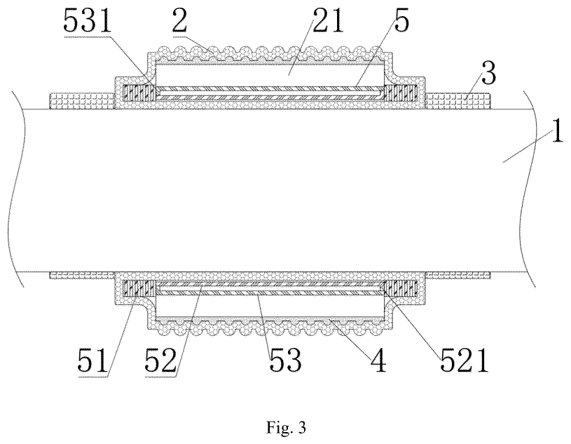

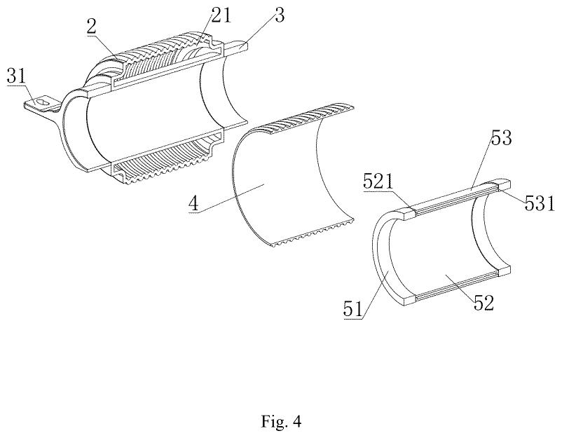

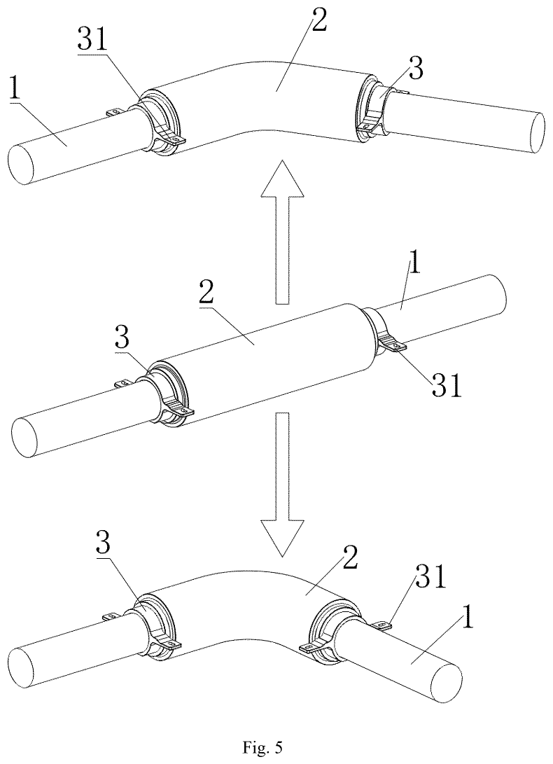

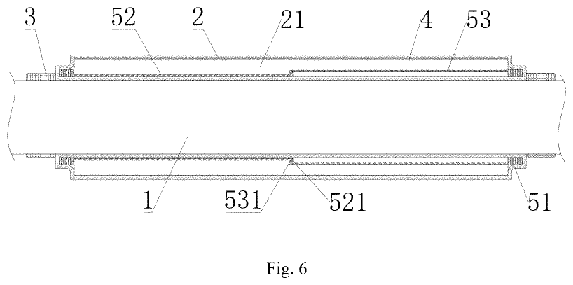

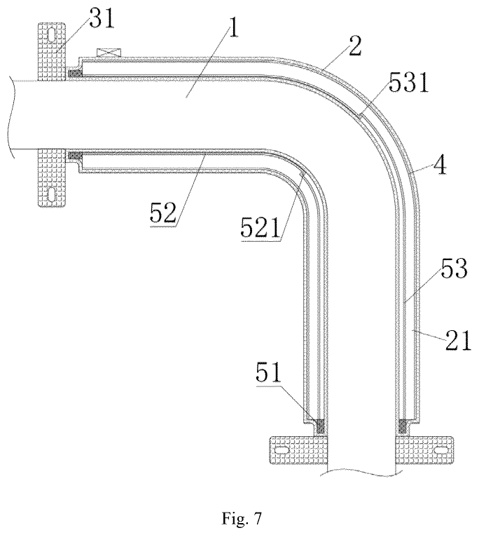

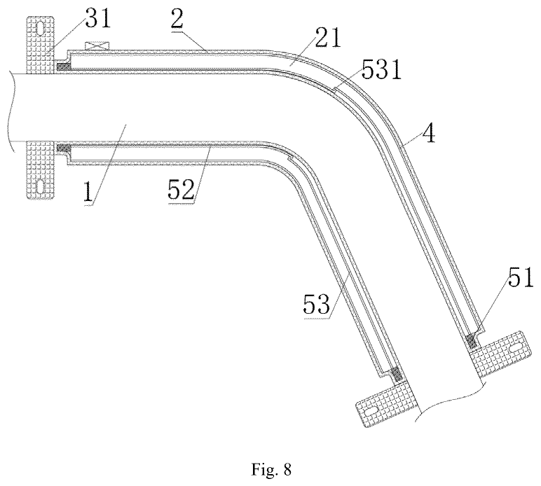

FIGS. 1 and 3 to 8 show a cold-resistant medium-voltage power cable, including: a cable body 1; wherein a bending protection sleeve 2 is slidably sleeved over an outer end of the cable body 1; a clamping disc 3 is bolted to each of a left end and a right end of the bending protection sleeve 2, and the clamping disc 3 is slidably engaged with the cable body 1; a regulation protection cavity 21 is provided inside the bending protection sleeve 2; a flexible electric heating patch 4 is fixedly connected to an inner wall of the regulation protection cavity 21 on a side thereof that is far from the cable body 1; and a bending sensing assembly 5 configured to cooperate with the flexible electric heating patch 4 is arranged between a left inner wall and a right inner wall of the regulation protection cavity 21.

The bending sensing assembly 5 includes a trigger pad 51 fixedly connected to each of the left inner wall and the right inner wall of the regulation protection cavity 21; an inner telescopic sensing coil 52 is fixedly connected to a right end of the trigger pad 51 that is fixed to the left inner wall of the regulation protection cavity 21; an outer telescopic sensing coil 53 is fixedly connected to a left end of the trigger pad 51 that is fixed to the right inner wall of the regulation protection cavity 21, and the outer telescopic sensing coil 53 is located on an outer side of the inner telescopic sensing coil 52; an inner sensing contact block 521 is fixedly connected to a right end of the inner telescopic sensing coil 52; an outer sensing contact block 531 configured to cooperate with the inner sensing contact block 521 is fixedly connected to a left end of the outer telescopic sensing coil 53; and the flexible electric heating patch 4 is connected to the inner sensing contact block 521 and the outer sensing contact block 531 via wires. Through the cooperative use of the bending protection sleeve 2, the clamping disc 3, the flexible electric heating patch 4, and the bending sensing assembly 5, this arrangement provides enhanced protection for the bent installation section of the cable body 1 when the cable body 1 is installed in cold regions. On one hand, the arrangement reduces the difficulty in bending the cable body 1 during installation, prevents damage to the cable body 1 caused by excessive bending, and improves the efficiency and safety of installing the cable body 1 in cold regions, while also utilizing an elastic protection mechanism to support the bent portion of the cable body 1, thereby reducing continuous damage to the cable body 1 caused by the bending moment and prolonging the service life of the bent portion of the cable body 1 in cold regions; on the other hand, the arrangement enables heating treatment at a bent installation section of the cable body 1. This configuration not only enhances flexibility of the cable body 1 during installation, reducing damage to internal conductive cores of the cable body 1, but also provides continuous thermal protection to the bent installation section during subsequent operation of the cable body 1. As a result, the disclosed cable reduces the degree to which the bent portion is affected by low temperatures, lowers the risk of the bent portion becoming hardened or even cracked, improves the durability of the cable body 1 after installation, and effectively ensures the safety and stability of the cable body 1 during power transmission.

FIGS. 1 and 3 to 8 illustrate that when the cable body 1 is intended for use in cold regions, installation personnel first sleeve the bending protection sleeve 2 and the clamping discs 3 onto a section of the cable body 1 requiring bending. The bending protection sleeve 2 is then stretched according to the bending position of the cable body 1. After fixing one of the left or right clamping discs 3 at the bending start position, the other clamping disc 3 is slid to cause the bending protection sleeve 2 to undergo elongation deformation. During this elongation deformation of the bending protection sleeve 2, the two bending sensing assemblies 5 within the regulation protection cavity 21 move away from each other, such that the inner telescopic sensing coil 52 and the outer telescopic sensing coil 53 move toward each other. When the outer sensing contact block 531 moves into contact with the inner sensing contact block 521, the outer sensing contact block 531 and the inner sensing contact block 521 engage in a latching contact. This engagement causes the flexible electric heating patch 4 to be energized and generate heat. The flexible electric heating patch 4 heats the inner portion of the regulation protection cavity 21, and this heat is transferred to act upon the cable body 1. Through this heating action, the flexibility of the cable body 1 is restored. Subsequently, the installation personnel bend the section of the cable body 1 equipped with the bending protection sleeve 2 and fix the bend using the clamping disc 3 at the other end. To maintain the bent shape of the bending protection sleeve 2, the installation personnel may fix the bending protection sleeve 2 at a suitable position or clamp the bending protection sleeve 2 into a preset guide groove, thereby completing the bending installation of the cable body 1. This process not only reduces the difficulty of bending and installing the cable body 1 in cold weather, minimizing damage to the cores of the cable body 1 caused by reduced flexibility during bending, but also utilizes an elastic protection mechanism to support the bent portion of the cable body 1, thereby reducing continuous damage to the cable body 1 caused by the bending moment and prolonging the service life of the bent portion of the cable body 1 in cold regions.

After the cable body 1 is installed and in continuous use, the heat generated by the flexible electric heating patch 4 maintains the flexibility of the cable body 1 at that location. Consequently, damage to the bent installation section of the cable body 1, caused by the combined effects of bending moments and cold weather, is reduced. This effectively counteracts the impacts of cold weather, thereby enhancing the durability of the bent installation section of the cable body 1 and lowering the risk of the bent section becoming hardened or even cracked. This effectively ensures the safety and stability of the cable body 1 during power transmission.

### Embodiment 2

FIGS. 1 to 8 show a cold-resistant medium-voltage power cable. As a functional addition to Embodiment 1, those skilled in the art can select this embodiment according to actual needs. A microcontroller is further fixedly connected to a left side of a rear end of the bending protection sleeve 2; the microcontroller is loaded with a bending protection subsystem cooperating with a cable maintenance platform; the bending protection subsystem includes a bending protection processing unit; an input end of the bending protection processing unit is connected to a cable parameter acquisition unit and a bending sensing acquisition unit; and an output end of the bending protection processing unit is connected to a heat preservation protection unit and an abnormality alarm unit.

An input end of the cable parameter acquisition unit is in signal communication with the cable maintenance platform via a wireless signal transmitter. An input end of the bending sensing acquisition unit is in signal communication with the inner sensing contact block 521 and the outer sensing contact block 531. The inner sensing contact block 521 and the outer sensing contact block 531 form an annular trigger switch; when the entire annular surface of the inner sensing contact block 521 and the outer sensing contact block 531 abuts, transmission and conduction of an abutting signal is formed, otherwise the switch is in an open state. An output end of the heat preservation protection unit is in signal communication with the flexible electric heating patch 4. An output end of the abnormality alarm unit is in signal communication with the cable maintenance platform via a wireless signal transmitter. Provision of the bending protection subsystem enables independent protection and detection of the bending installation section of the cable body 1. On one hand, the bending protection subsystem enhances the intelligence of the heat preservation protection effect provided by the flexible electric heating patch 4 on the bending section. On the other hand, by continuously monitoring the abutting state of the inner sensing contact block 521 and the outer sensing contact block 531, the bending protection subsystem assists in judging whether the bending installation section of the cable body 1 is in good condition, thereby providing auxiliary maintenance for the cable body 1. This configuration enables the cable body 1 to effectively withstand cold weather during subsequent use, and also effectively solves the problem of inconvenient maintenance and monitoring of the cable body 1 caused by cold weather.

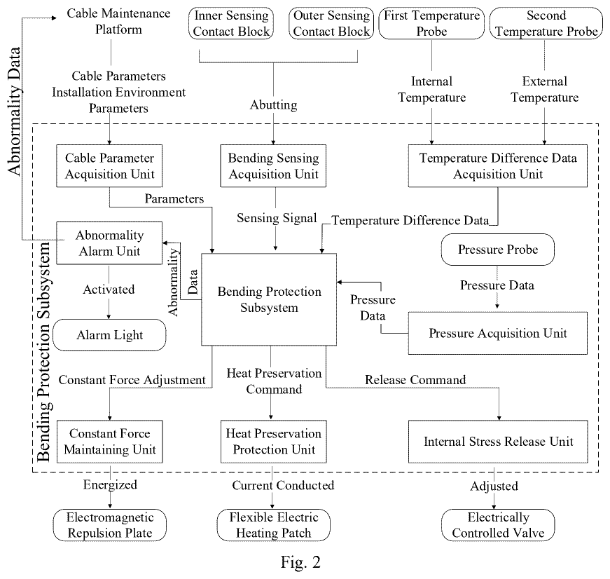

FIG. 2 shows that a power supply interface and a solar charging structure are respectively provided at a rear end of the microcontroller. The power supply interface and the solar charging structure are connected to the microcontroller via independent lines. Provision of the power supply interface and the solar charging structure provides multiple power supply options for the microcontroller, thereby enhancing the applicability of the microcontroller during installation of the cable body 1. A suitable power supply method can be selected according to the installation environment, thereby ensuring normal operation of the microcontroller and improving the protective effect on the cable body 1.

FIGS. 1 to 8 show that a support lug 31 is fixedly connected to each of a front end and a rear end of the clamping disc 3. A mounting hole is formed in the support lug 31. The output end of the abnormality alarm unit is further in signal communication with an alarm light mounted on the support lug 31. The cooperation between the clamping disc 3 and the support lug 31 facilitates the bending, installation, and mounting of the cable body 1, and also enables cooperation with the abnormality alarm unit to generate a light warning when damage occurs at the bent section of the cable body 1. This facilitates timely identification of the abnormal location by maintenance personnel and reduces the difficulty of maintaining the cable body 1 in cold regions.

FIG. 2 shows that the input end of the bending protection processing unit is further connected to a temperature difference data acquisition unit. An input end of the temperature difference data acquisition unit is in signal communication with a first temperature probe provided on an inner wall of the regulation protection cavity 21 and a second temperature probe provided on an outer end of the bending protection sleeve 2, respectively. Provision of the temperature difference data acquisition unit assists the bending protection subsystem in determining the internal and external environment of the bending protection sleeve 2. While ensuring the effectiveness of heat preservation at the bent section of the cable body 1, the temperature difference data acquisition unit can also instruct the flexible electric heating patch 4 to deactivate its electric heating function when the ambient temperature is sufficiently high, thereby achieving effective energy saving and environmental protection, and further enhancing the environmental adaptability of the bending protection subsystem.

FIGS. 2 and 6 to 8 show that the output end of the bending protection processing unit is further connected to a constant force maintaining unit. Electromagnetic repulsion plates are fixedly connected to an end of the flexible electric heating patch 4 close to the cable body 1 and to an end of the outer telescopic sensing coil 53 far from the cable body 1, respectively. An output end of the constant force maintaining unit is in signal communication with the electromagnetic repulsion plates. Provision of the constant force maintaining unit ensures positional effectiveness of the inner sensing contact block 521 and the outer sensing contact block 531 during the bending installation process of the cable body 1, thereby avoiding contact abnormalities and other problems between the inner sensing contact block 521 and the outer sensing contact block 531 caused by the bending state, and ensuring the effectiveness of subsequent heat preservation protection for the cable body 1.

FIGS. 1 to 8 illustrate that when the cable body 1 is applied in cold regions, the installation technician can select the power connection method for the microcontroller according to the installation location of the cable body 1. At locations with a power supply device, the power supply interface is selected for power supply to ensure stability of the power supply. At locations without a power supply device, the solar charging structure is selected as the power supply, utilizing green energy storage to reduce the installation and maintenance costs of the cable body 1 and to ensure data transmission between the cable maintenance platform and the bending protection subsystem, thereby promoting the protection and monitoring of the cable body 1. During installation of the cable body 1, the cable technician transmits basic data concerning the cable body 1 and data concerning the installation environment of the cable body 1 to the cable parameter acquisition unit via the cable maintenance platform and the wireless signal transmitter. The basic data concerning the cable body 1 includes the cable diameter, the required bending installation precision, and other data. The data concerning the installation environment includes the annual temperature variation range and other parameters. The cable parameter acquisition unit then transmits these parameter data to the bending protection processing unit. The bending protection processing unit processes and stores these data.

Subsequently, during installation of the cable body 1, specifically when the actions of the installation personnel cause the inner sensing contact block 521 and the outer sensing contact block 531 to abut and contact, the bending sensing acquisition unit receives the abutting signal and transmits this abutting signal to the bending protection processing unit. The bending protection processing unit determines that bending construction of the cable body 1 is required at this time, and then transmits a control command to the heat preservation protection unit, such that the heat preservation protection unit controls the flexible electric heating patch 4 to generate an electric heating action. This provides heat preservation protection to the bending position of the cable body 1, reducing the impact of cold on the flexibility of the cable body 1, thereby enabling the installation personnel to effectively bend the cable body 1 and reducing bending damage to the cable body 1. Before the bending protection processing unit controls the heat preservation protection unit, the temperature difference data acquisition unit receives the internal and external temperature data transmitted by the first temperature probe and the second temperature probe. The temperature difference data acquisition unit then transmits these internal and external temperature data to the bending protection processing unit, enabling the bending protection processing unit to issue appropriate control commands to the heat preservation protection unit based on the current temperature data. This restores the flexibility of the cable body 1 while also avoiding damage to the cable body 1 caused by excessively high temperatures, and avoiding damage to the electromagnetic repulsion plates inside the regulation protection cavity 21. While controlling the heat preservation protection unit, the bending protection processing unit also transmits a control command to the constant force maintaining unit, such that the constant force maintaining unit supplies current to the electromagnetic repulsion plates. This causes the electromagnetic repulsion plates located on the flexible electric heating patch 4 and the electromagnetic repulsion plates located on the outer telescopic sensing coil 53 to generate identical magnetic forces. Under the action of magnetic repulsion, the outer telescopic sensing coil 53 is maintained continuously close to the inner telescopic sensing coil 52. Consequently, during the bending construction process of the cable body 1, the effectiveness of the abutment between the inner sensing contact block 521 and the outer sensing contact block 531 is ensured, the continuity of the heat preservation provided by the heat preservation protection unit is ensured, and the effectiveness of subsequent state monitoring of the bending installation section of the cable body 1 is ensured.

After installation of the cable body 1 is completed, the bending protection processing unit adaptively adjusts the action of the heat preservation protection unit based on the temperature data and temperature difference data transmitted by the temperature difference data acquisition unit. When the ambient temperature is relatively low, the electric heating action of the flexible electric heating patch 4 is maintained to avoid damage to the bending installation position of the cable body 1 caused by low temperature. When the ambient temperature is sufficiently high, the electric heating action of the flexible electric heating patch 4 is reduced or stopped, thereby achieving effective energy saving and environmental protection while protecting the cable body 1 from damage. If, due to prolonged use, damage still occurs at the bending installation position of the cable body 1, resulting in cracking or breakage of the insulation layer, the shielding layer, and the protective layer, such that the insulation layer, the shielding layer, and the protective layer lose supporting force, which in turn causes significant deformation at the bending position of the cable body 1, and this deformation applies a local squeezing action to the bending protection sleeve 2. This local squeezing action causes local deformation of the regulation protection cavity 21, which counteracts the magnetic repulsion between the trigger pad 51 and the flexible electric heating patch 4, resulting in misalignment or lifting of the inner sensing contact block 521 and the outer sensing contact block 531. Consequently, the bending sensing acquisition unit cannot receive the abutting signal, and the bending sensing acquisition unit ceases to transmit the abutting signal to the bending protection processing unit. Therefore, the bending protection processing unit determines that the bending installation position of the cable body 1 is damaged, and then transmits abnormality data to the abnormality alarm unit. This causes the abnormality alarm unit to transmit the abnormality data to the cable maintenance platform via the wireless signal transmitter, enabling the cable maintenance platform to issue an abnormality indication to the cable maintenance personnel. Simultaneously, the abnormality alarm unit activates the alarm light on the support lug 31, providing a warning function. On one hand, this facilitates the cable maintenance personnel in locating the abnormal position, improving maintenance efficiency. On the other hand, this provides a reminder function for inspection personnel, further providing an indicative effect for maintenance reminders.

### Embodiment 3

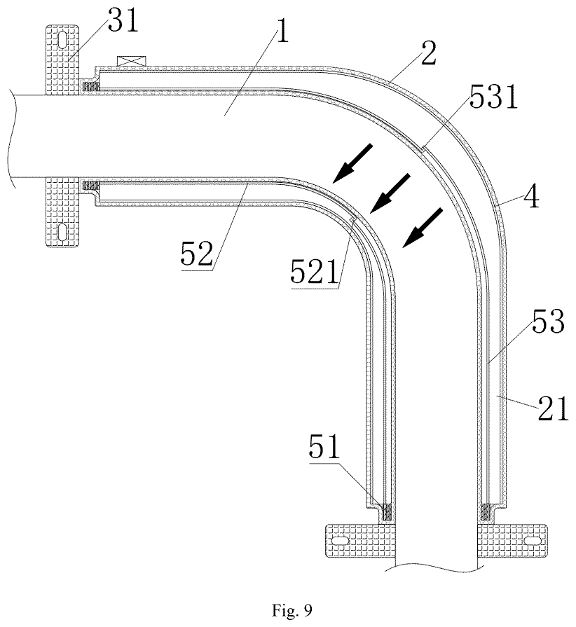

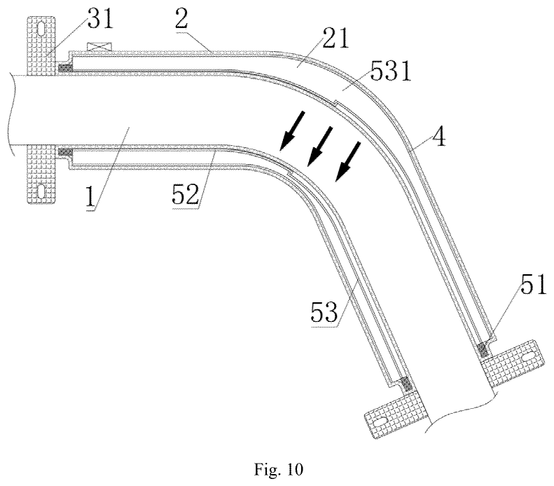

FIGS. 1 to 6, 9, and 10 show a cold-resistant medium-voltage power cable. As a functional addition to Embodiment 2, those skilled in the art can select this embodiment according to actual needs. The regulation protection cavity 21 is filled with inert protective gas. A pressure regulating interface configured to communicate with the regulation protection cavity 21 is fixedly connected to a right side of the rear end of the bending protection sleeve 2. The output end of the bending protection processing unit is further connected to an internal stress release unit. An output end of the internal stress release unit is in signal communication with an electrically controlled valve provided on the pressure regulating interface. Filling with the inert protective gas enhances the protective effect of the bending protection sleeve 2 on the cable body 1, providing effective protection and buffering. Furthermore, in cooperation with the provision of the internal stress release unit, after the bending installation of the cable body 1 is completed, the internal stress release unit is configured to reduce the pressure of the inert protective gas within the regulation protection cavity 21, thereby releasing the restrictive effect of the bending protection sleeve 2 on the bent arc of the cable body 1. Consequently, damage to the cable body 1 caused by the bending moment can be reduced by increasing the bending arc of the cable body 1, further prolonging the service life of the cable body 1.

FIG. 2 shows that the input end of the bending protection processing unit is further connected to a pressure acquisition unit. An input end of the pressure acquisition unit is in signal communication with a pressure probe provided in the regulation protection cavity 21. Provision of the pressure acquisition unit assists the application of the internal stress release unit, improving the pressure release accuracy of the internal stress release unit. This ensures the effectiveness of monitoring by the inner sensing contact block 521 and the outer sensing contact block 531 while ensuring the release of the arc of the cable body 1.

FIGS. 1 to 6, 9, and 10 illustrate that when the pressure acquisition unit and the internal stress release unit are selected for use, the bending protection processing unit first determines the pressure data required to release the bending arc of the cable based on the data concerning the cable and the data concerning the cable bending installation transmitted by the cable parameter acquisition unit. After installation of the cable body 1 is completed, the pressure probe transmits the current pressure data within the regulation protection cavity 21 to the pressure acquisition unit. The bending protection processing unit then receives the pressure data transmitted by the pressure acquisition unit, performs calculation processing using this pressure data and the aforementioned calculated required release pressure data, and subsequently transmits a release command to the internal stress release unit. This causes the internal stress release unit to open the electrically controlled valve on the pressure adjustment interface, releasing the inert protective gas within the regulation protection cavity 21 at that time. After sufficient release of the pressure, the electrically controlled valve on the pressure adjustment interface is closed. By releasing pressure, the restrictive effect of the bending protection sleeve 2 on the bending arc of the cable body 1 is reduced, such that the cable body 1 undergoes a release of its bending arc under its own elastic action. Thereby, damage to the cable body 1 caused by the bending moment is reduced by increasing the bending arc, providing effective protection and further promoting the durability of the bending installation section of the cable body 1 in cold environments.

Based on current practical requirements, the protection scope of the above embodiments adopted in the present disclosure is not limited thereto. Various changes made without departing from the concept of the present disclosure, within the knowledge scope of those skilled in the art, still fall within the protection scope of the present disclosure.

What is claimed is:

1. A cold-resistant medium-voltage power cable, comprising: a cable body (1); wherein a bending protection sleeve (2) is slidably sleeved over an outer end of the cable body (1); a clamping disc (3) is bolted to each of a left end and a right end of the bending protection sleeve (2), and the clamping disc (3) is slidably engaged with the cable body (1); a regulation protection cavity (21) is provided inside the bending protection sleeve (2); a flexible electric heating patch (4) is fixedly connected to an inner wall of the regulation protection cavity (21) on a side thereof that is far from the cable body (1); and a bending sensing assembly (5) configured to cooperate with the flexible electric heating patch (4) is arranged between a left inner wall and a right inner wall of the regulation protection cavity (21); and
the bending sensing assembly (5) comprises a trigger pad (51) fixedly connected to each of the left inner wall and the right inner wall of the regulation protection cavity (21); an inner telescopic sensing coil (52) is fixedly connected to a right end of the trigger pad (51) that is fixed to the left inner wall of the regulation protection cavity (21); an outer telescopic sensing coil (53) is fixedly connected to a left end of the trigger pad (51) that is fixed to the right inner wall of the regulation protection cavity (21), and the outer telescopic sensing coil (53) is located on an outer side of the inner telescopic sensing coil (52); an inner sensing contact block (521) is fixedly connected to a right end of the inner telescopic sensing coil (52); an outer sensing contact block (531) configured to cooperate with the inner sensing contact block (521) is fixedly connected to a left end of the outer telescopic sensing coil (53); and the flexible electric heating patch (4) is connected to the inner sensing contact block (521) and the outer sensing contact block (531) via wires.

2. The cold-resistant medium-voltage power cable according to claim 1, wherein a microcontroller is further fixedly connected to a left side of a rear end of the bending protection sleeve (2); the microcontroller is loaded with a bending protection subsystem cooperating with a cable maintenance platform; the bending protection subsystem comprises a bending protection processing unit; an input end of the bending protection processing unit is connected to a cable parameter acquisition unit and a bending sensing acquisition unit; and an output end of the bending protection processing unit is connected to a heat preservation protection unit and an abnormality alarm unit; and
an input end of the cable parameter acquisition unit is in signal communication with the cable maintenance platform via a wireless signal transmitter; an input end of the bending sensing acquisition unit is in signal communication with the inner sensing contact block (521) and the outer sensing contact block (531); an output end of the heat preservation protection unit is in signal communication with the flexible electric heating patch (4); and an output end of the abnormality alarm unit is in signal communication with the cable maintenance platform via a wireless signal transmitter.

3. The cold-resistant medium-voltage power cable according to claim 2, wherein a support lug (31) is fixedly connected to each of a front end and a rear end of the clamping disc (3); a mounting hole is formed in the support lug (31); and the output end of the abnormality alarm unit is further in signal communication with an alarm light mounted on the support lug (31).

4. The cold-resistant medium-voltage power cable according to claim 2, wherein a power supply interface and a solar charging structure are respectively provided at a rear end of the microcontroller; and the power supply interface and the solar charging structure are connected to the microcontroller via independent lines.

5. The cold-resistant medium-voltage power cable according to claim 2, wherein the regulation protection cavity (21) is filled with inert protective gas; a pressure regulating interface configured to communicate with the regulation protection cavity (21) is fixedly connected to a right side of the rear end of the bending protection sleeve (2); the output end of the bending protection processing unit is further connected to an internal stress release unit; and an output end of the internal stress release unit is in signal communication with an electrically controlled valve provided on the pressure regulating interface.

6. The cold-resistant medium-voltage power cable according to claim 5, wherein the input end of the bending protection processing unit is further connected to a pressure acquisition unit; and an input end of the pressure acquisition unit is in signal communication with a pressure probe provided in the regulation protection cavity (21).

7. The cold-resistant medium-voltage power cable according to claim 2, wherein the input end of the bending protection processing unit is further connected to a temperature difference data acquisition unit; and an input end of the temperature difference data acquisition unit is in signal communication with a first temperature probe provided on an inner wall of the regulation protection cavity (21) and a second temperature probe provided on an outer end of the bending protection sleeve (2), respectively.

8. The cold-resistant medium-voltage power cable according to claim 2, wherein the output end of the bending protection processing unit is further connected to a constant force maintaining unit; electromagnetic repulsion plates are fixedly connected to an end of the flexible electric heating patch (4) close to the cable body (1) and to an end of the outer telescopic sensing coil (53) far from the cable body (1), respectively; and an output end of the constant force maintaining unit is in signal communication with the electromagnetic repulsion plates.
